(19) United States
(12) Patent Application Publication
(10) Pub. No.: US 2011/0158473 A1
(43) Pub. Date: Jun. 30, 2011

(54) DETECTING METHOD FOR DETECTING MOTION DIRECTION OF PORTABLE ELECTRONIC DEVICE

(76) Inventors: Tsung-Ting SUN, Taipei (TW); Chung-Ping Feng, Taipei (TW)

(21) Appl. No.: 12/649,022

(22) Filed: Dec. 29, 2009

(51) Int. Cl. G06K 9/00; H04N 5/335

(52) U.S. Cl. 382/103; 348/311; 348/308; 348/E05.091

(57) ABSTRACT

A detecting method is provided for detecting motion direction of a portable electronic device. The portable electronic device senses a plurality of continuous images in time sequence via an image sense unit. The differences among the plurality of images are analyzed by a process unit. Consequently the process unit determines the motion direction of the portable electronic device, generates motion data based on the differences, and sends a control signal corresponding to the motion direction of the device and the motion data.

### BACKGROUND OF THE INVENTION

1. Field of the Invention

The present invention generally relates to a detecting method, in particular, to a method for detecting motion direction of a portable electronic device.

2. Description of Prior Art

As the information technology develops rapidly nowadays, various electronic devices become popular in daily life. In particular, portable electronic device with diversified functions have become a critical part of modern life. Portable electronic device are characterized by being compact and low power consumption. Users are given the conveniences to use the devices anywhere anytime. Consequently, engineers are working on making the electronic devices portable in recent years. Mobile phones, portable MP3 players and digital cameras are typical products resulted from the engineering effort making products compact and portable. Under the trend, electronic devices are becoming more and more popular and convenient to users.

Frequently, the demand of an electronic device grows rapidly when the device becomes portable. In order to cover requirements from different customer groups, developers start to develop and offer value added functions such as photo taking function on a mobile phone or a MP3 player. Furthermore, products are provided with screen touch control function and wireless network access in order to make the electronic products become more attractive to potential users. Recently, touch control mobile phones such as I-Phone from Apple or HTC Touch Diamond from HTC further provide sensing flip and rotate movements, marking a new direction for mobile phone market.

In addition to two models of touch control mobile phone above, there are also portable electronic device in the market capable of sensing flip and rotate movements implemented by an accelerometer or a gyro installed. Users control the electronic device by flip and rotate the electronics device. The electronic device senses tilted angles and speeds of the electronic device caused by the motion and sends instructions based on the sensed angles and speeds processed by a program to control motion of the electronic device. In some applications, users are capable of playing interactive games on an electronic device by flip and rotate the device.

However, it is a pity that the above mentioned electronic devices are provided with capability sensing flip and rotate action of the devices, and have not fully utilized and studied on two-dimensional translation. Moreover, an accelerometer and a gyro are additional components added to an electronic device. The cost to add the accelerometer or the gyro may not be significant. Yet the total cost to add the component to an electronic device under mass production still stands for a portion in overall cost for manufacturers.

In terms of the above disadvantages, an electronic device and method are demanded in the market capable of sensing the motion of an electronic device surrounding the electronic device and further transforming the sensed data into a control signal controlling action of the electronic device without adding sensing components.

### SUMMARY OF THE INVENTION

The objective of the present invention is to provide a detecting method for detecting motion direction of a portable electronic device. Upon the electronic device has motion under an external force, the electronic device determines an angel or a direction of the motion and sends a corresponding control signal for controlling action of the electronic device.

In order to realize the above objective, an image sense unit is used according to the present invention for sensing a plurality of images in continuous time sequence. In addition, a process unit is used for analyzing differences among the plurality of images for determining motion direction of the electronic device to generate motion data and sends control signal corresponding to the motion data.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1A is a front view of a portable electronic device of a preferred embodiment according to the present invention;

FIG. 1B is a back view of a portable electronic device of a preferred embodiment according to the present invention;

FIG. 2 is a block diagram of a portable electronic device of a preferred embodiment according to the present invention;

FIGS. 3A, 3B, 3C and 3D are schematic views illustrating an image sense process of a preferred embodiment according to the present invention;

FIG. 4 is a flow chart of a preferred embodiment according to the present invention;

FIG. 5A is an application schematic view of a preferred embodiment according to the present invention; and

FIG. 5B is the other application schematic view of a preferred embodiment according to the present invention.

### DETAILED DESCRIPTION OF THE INVENTION

In cooperation with attached drawings, the technical contents and detailed description of the present invention are described thereinafter according to a preferable embodiment.

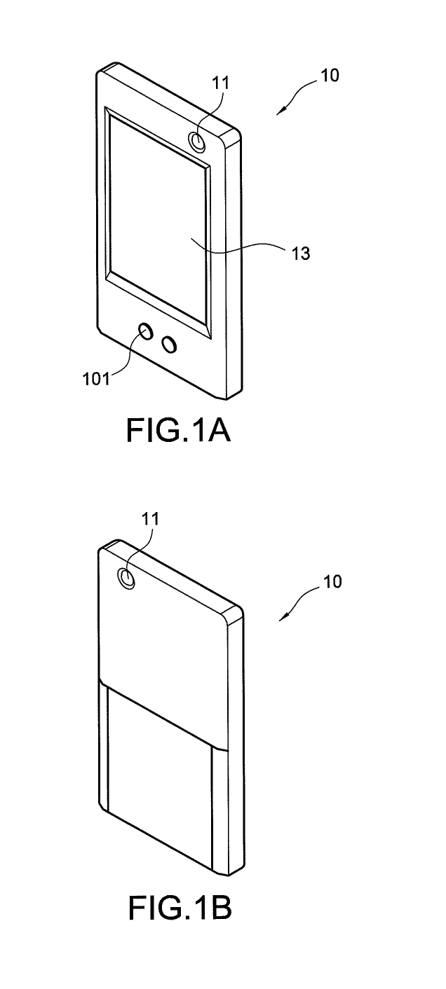

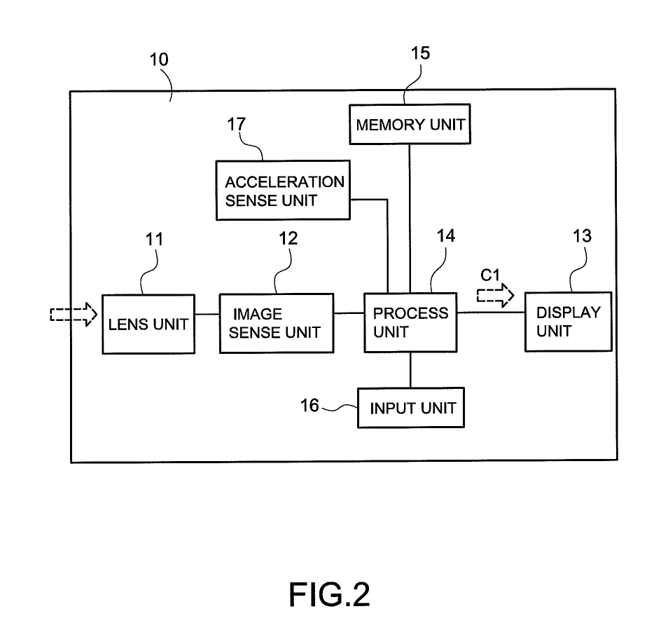

FIG. 1A and FIG. 1B are front view and back view of a portable electronic device of a preferred embodiment according to the present invention. The electronic device 10 of the present invention has one or more than one input buttons 101 used for sending an input signal following the input button 101 is triggered. A lens unit 11 is disposed externally on the electronic device 10 on any side of the electronic device 10. The lens unit 11 is disposed on the front side in FIG. 1A, and the lens unit 11 is disposed on the back side of the electronic device in FIG. 1B. The lens unit 11 is used for receiving external light for generating image of external image on the image sense unit 12 of the electronic device 10 (as shown in FIG. 2). Preferably, the image sense unit 12 is an image sensor using Charge Coupled Device (CCD) or a Complementary Metal Oxide Semiconductor (CMOS) depending on the application purpose. The suggested embodiment of the image sensor above should not limit scope of the present invention. When the electronic device 10 is a mobile phone, Personal Digital Assistant (PDA), Global Positioning System (GPS) or digital video/audio player, the electronic device 10 further comprises a display unit 13 for displaying an object corresponding to motion angle or direction of the electronic device 10.

FIG. 2 is a block diagram of a portable electronic device of a preferred embodiment according to the present invention. The electronic device 10 has a lens unit 11, an image sense unit 12, a display unit 13, a process unit 14, a memory unit 15 and an input unit 16. External images are refracted via the lens unit 11 in continuous time sequence and generated on the image sense unit 12. The image sense unit 12 senses differences of the external images. The image sense unit 12 senses a plurality of continuous images, which are sent to the process unit 14 for image analyzing. The differences among the plurality of images sensed are used for determining a motion direction of the electronic device 10 and generating motion data, wherein the motion direction of the electronic device 10 can be categorized into one-dimensional rotation motion (in the present invention, one-dimensional rotation motion means that the rotation motion can be expressed by one variable, namely, rotation angle, even though the rotation motion is actually exercised in two or three-dimensional space) or two-dimensional translation motion (detailed in the following). Lastly, these sensed images and the motion data are saved in the memory unit 15 and a corresponding control signal C1 is sent based on the motion data. The input unit 16 is triggered by the input button 101 to send the input signal to the process unit 14. The process unit 14 sends the corresponding control signal C1. In addition to sensing motion direction of the electronic device 10, the electronic device 10 may further include an acceleration sense unit 17 used for sensing the translation and rotation speed of the electronic device 10. The motion speed of the electronic device 10 is also factor for generating motion data and has impact on the control signal C1.

It should be noted that the objective of the present invention is determining the motion direction of the portable electronic device 10 upon external force via sensing external image differences. Therefore, image quality of the plurality of images generated on the image sense unit 12 is expected to reach a level sufficient for effective determination on the image differences. The quality requirement standard is not as stringent as the standard demanded by general digital photos for sharing and records by users. Thus, it is not required to install devices to retrieve and process data for generating high quality digital images. Instead, the required device of the embodiment is an image sense unit 12. It is not needed to use a well equipped digital camera.

According the preferred embodiment, the control signal C1 sent is used for controlling an object displayed on the display unit 13 of the electronic device 10. As shown in FIG. 1A, the electronic device 10 has the display unit 13. When the electronic device 10 is a mobile phone or a digital audio/video player with display function, users may perform interactive operations with the control signal C1 and the object displayed on the display unit 13 of the electronic device 10 as a result of the motion. For example, the interactive operations can be changing menu of the mobile phone, switching songs played in the audio/video player, playing interactive games. It should be noted that the above is used as a preferred embodiment of the present invention and should not be used for limiting the scope of the present invention.

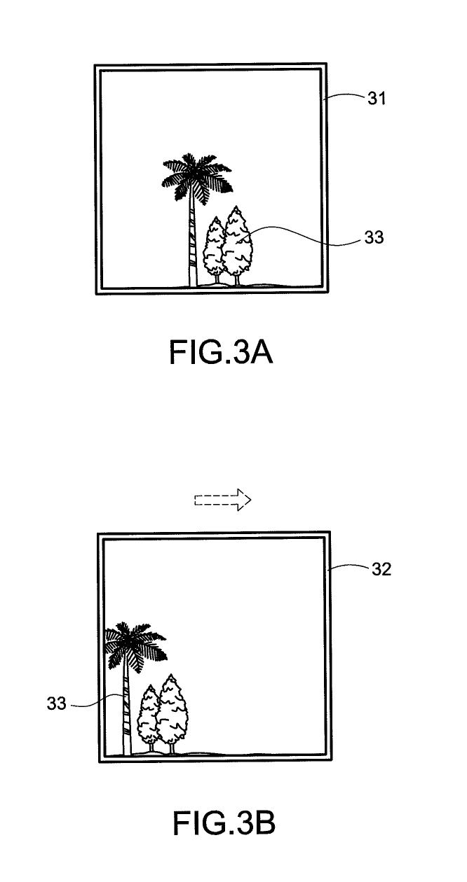

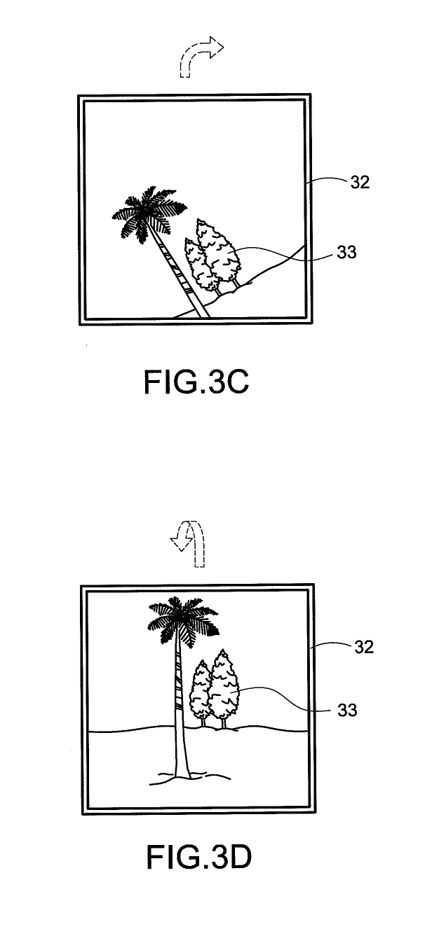

FIGS. 3A, 3B, 3C and 3D are schematic views illustrating an image sense process of a preferred embodiment according to the present invention. In the preferred embodiment according to the present invention, the determination on image differences sensed by the image sense unit 12 does not have to be a complete image. However, the preferred embodiment uses a complete image so as to clearly explaining the technical characteristics of the present invention. FIG. 3A is a schematic view of a first image 31 sensed by the image sense unit 12 of the electronic device 10. The first image 31 is used as a start point before proceeding to steps for determining motion direction of the electronic device 10. The image sense unit 12 senses a second image 32 in the following as shown in FIG. 3B, wherein the position of the target 33 shown moves to the left of the image in contrast with the position of the same target 33 in the first image 31. The process unit 14 analyzes the image differences, determines that the electronic device 10 has a translation motion to the right under external force, generates the corresponding motion data and sends the control signal C1 corresponding to the translation motion for controlling the object action of electronic device 10.

When the second image 32 is as shown in FIG. 3C, the position of the target 33 is tilted towards a counter clockwise direction in contrast with the position in the first image 31. Accordingly, the process unit 14 determines that the electronic device 10 has a clockwise rotation motion. When the image is as shown in FIG. 3D, the position of the target 33 moves forward to the front in contrast with the position in the first image 31. The process unit 14 determines that the electronic device 10 has a downward rotation motion. Accordingly, the electronic device 10 generates the motion data and sends the control signal C1 corresponding to the rotation motion for controlling object action of the electronic device 10.

It should be noted that the preferred embodiment of the present invention should not limit the scope of the invention. In the above preferred embodiment, the motion direction indicated by of two images 31, 32 of the target 33 are used for determining the motion of the electronic device 10 motion. The electronic device 10 of the present invention can use a complete image sensed by the image sense unit 12 for determining motion direction. The differences of the target 33 in FIG. 3 are used as an exemplary illustration and should not limit the scope the invention.

The control signal C1 generated by the electronic device 10 of the present invention can be used in diversified applications. Depending on the application scenarios, the motion determination can be further categorized into the electronic device 10 having a one-dimensional rotation motion or two-dimensional translation motion and a more specific control signal C1 accordingly can be generated.

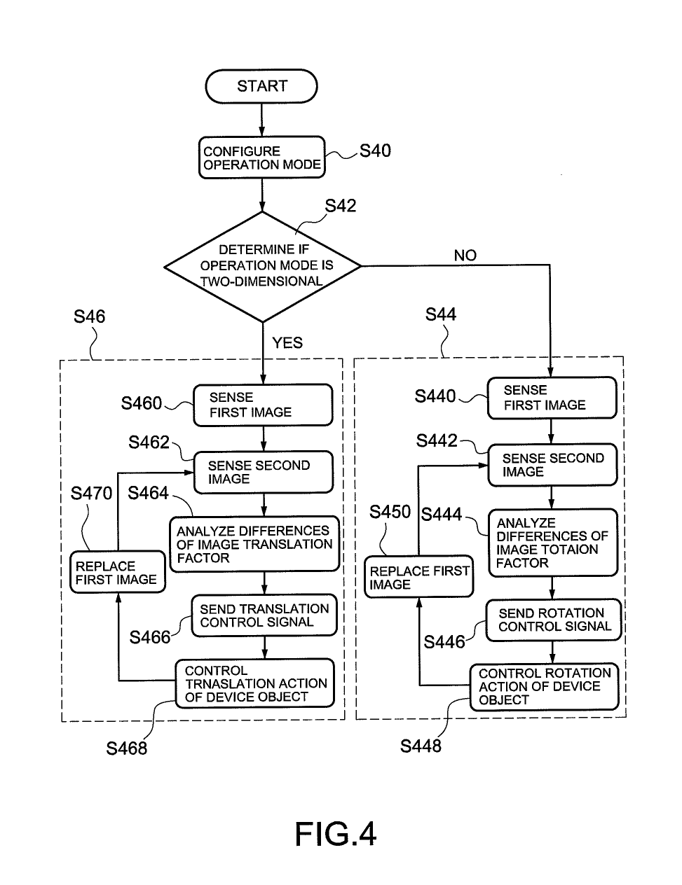

As mentioned above, FIG. 4 is a flow chart of a preferred embodiment according to the present invention. Firstly, the electronic device 10 is configured to be on an operation mode (step S40), wherein the configuration is used for indicating the image sensing and analyzing is dedicated on translation motion or rotation motion of the electronic device 10. The configuration of operation modes are subject to user's decision or object application scenarios of the electronic device 10 and are not defined in the preferred embodiment. Consequently, the process unit 14 determines if the operation mode configured is a two-dimension mode (step S42), in other words, determines if the image analyzing is dedicated on translation motion of the electronic device 10. If not, then the process moves to the step S44, where the determination process is dedicated to rotation motion of the electronic device 10. If yes, then the process moves to the step S46, where the determination process is dedicated to translation motion of the electronic device 10. The processes are detailed in the following.

The step S44 is further completed by the step S440 to the step S450. Firstly, the image sense unit 12 senses the first image 31 (step S440). The first image 31 is used for defining a start point of the electronic device 10. Following defining the start point, the image sense unit 12 senses the second image 32 in time sequence (step S442). The images 31, 32 are sent to the process unit 14 for determining and analyzing the differences of rotation factors of the image 31, 32 (step S444), and generating the corresponding motion data. Upon the analyzing is completed, if the electronic device 10 has rotation motion, the control signal C1 is generated corresponding to the rotation motion (step S446). The control signal C1 is sent for controlling the object on the electronic device 10 to perform rotation action (step S448). Lastly, the second image 32 replaces the first image 31 (step S450) to redefine the start point of the electronic device 10. The process then returns to the step S442 to proceed to the next round of image sensing activity.

In the step S42, if the operation mode is determined as a two-dimension mode, which means the operating mode is determined to analyze image differences of translation motion factors of the electronic device 10, the process moves to the step S46. The step S46 further completed by the step S460 to the step S470. Identical with the step S44, the image sense unit 12 senses the first image 31 (step S460). The first image 31 is used for defining a start point of the electronic device 10. Following defining the start point, the image sense unit 12 senses the second image 32 in time sequence (step S462). The images 31, 32 are sent to the process unit 14 for determination. Yet, in this part of S46, the process unit 14 analyzes and decides if the electronic device 10 has translation motion or not based on the images 31, 32. As a result, the process unit 14 analyzes the differences of translation factors between images 31, 32 (step S464), and generates the motion data. Upon the motion data is analyzed, the process unit 14 determines that the electronic device 10 has the translation motion, the process unit 14 generates control signal C1 corresponding to the translation motion (step S466). The control signal C1 sent is used for controlling the object of the electronic device 10 to perform translation action (step S468). Lastly, the second image 32 replaces the first image 31 (step S470), to redefine the start point of the electronic device 10. The process then returns to the step S462 to proceed to the next round of image sensing activity.

The above step S44 is used for determining if the electronic device 10 has rotation motion and the process unit 14 does not process factors related to translation motion of the electronic device 10. On the other hand, the step S46 is used for determining of the electronic device 10 has translation motion and the process unit 14 does not process factors related to rotation motion of the electronic device 10.

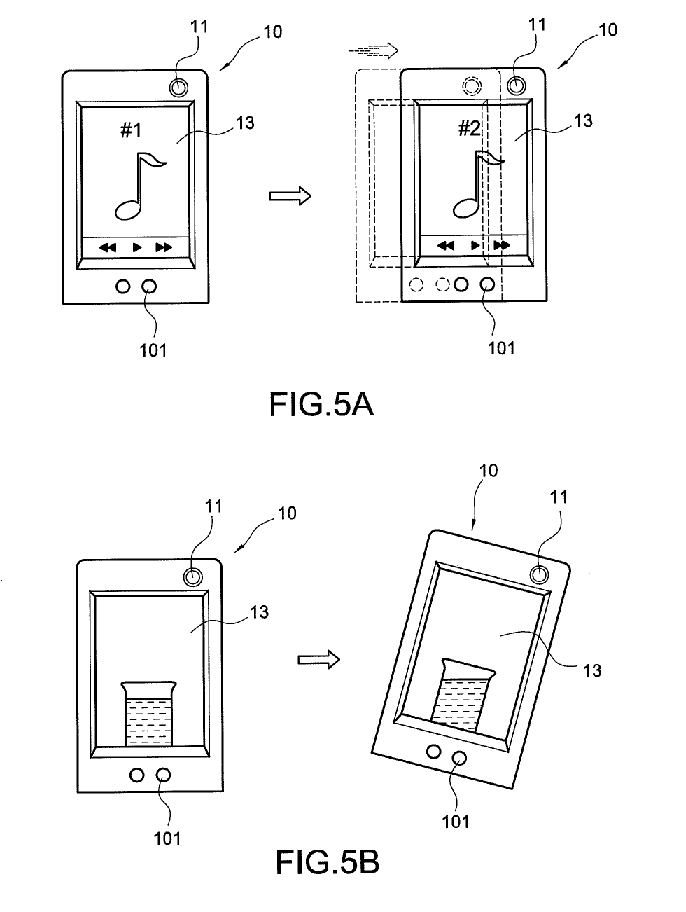

FIG. 5A and FIG. 5B are application schematic views according to the above process. In FIG. 5A, the menu of the electronic device 10 is controlled by translation motion of the electronic device 10 (for example: the switch of song playing as shown in the diagram). When the electronic device 10 is under external force and has translation motion to the right, the image sense unit 12 senses a plurality of continuous images in time sequence. The plurality of images are sent to the process unit 14 for analysis to determine that the electronic device 10 has translation motion to the right. The control signal C1 is sent corresponding to the translation motion for controlling the internal menu to switch the playing song from the first song to the second song in the menu. Song switch of the electronic device 10 is demonstrated in the FIG. 5A, the same mechanism can be extended to applications of digital photo switch or shortcut switch on a GPS, etc. following the above process.

In FIG. 5B, if the electronic device 10 is used for performing interactive games the present invention provide alternative interactions between users and devices. For example, the object rotation in a game can be controlled by determining if the electronic device 10 has rotation motion or not. When the electronic device 10 has clockwise rotation motion by an external force, the image sense unit 12 senses plurality of continuous images in time sequence. The images are sent to the process unit 14 for analysis to determine the electronic device 10 has clockwise rotation motion. The control signal C1 is then sent corresponding to rotation motion to control displayed the object on the display unit 13 instructing the object displayed to have a clockwise rotation motion as part of the game interaction.

As the skilled person will appreciate, various changes and modifications can be made to the described embodiments. It is intended to include all such variations, modifications and equivalents which fall within the scope of the invention, as defined in the accompanying claims.

What is claimed is:

1. A detecting method for detecting motion direction of a portable electronic device using an image sense unit sensing continuous images of space surrounding the portable electronic device in time sequence, a process unit analyzing and determining the motion direction of the portable electronic device for generating a corresponding control signal to control action of the portable electronic device, the method comprising:
a) sensing a first image used for defining a start point of the portable electronic device by the image sense unit;
b) sensing a second image by the image sense unit;
c) analyzing image differences between the first image and the second image to generate a motion data by the process unit;
d) sending the control signal according to the motion data;
e) replacing the first image with the second image to redefine the start point.

2. The detecting method of claim 1, wherein the image sense unit is an image sensor using a charge coupled device (CCD).

3. The detecting method of claim 1, wherein the image sense unit is an image sensor using a complementary metal oxide semiconductor (CMOS).

4. The detecting method of claim 1, wherein the process unit analyzes the differences of the image rotation factors between the first image and the second image to generate the motion data and sends the control signal corresponding to the rotation motion.

5. The detecting method of claim 4, wherein the method further comprises steps before the step a:
a0) receiving a configure signal for configuring an operation mode by the portable electronic device;
a1) determining if the operation mode is a two-dimension mode;
a2) following step a1, if no, proceeding to the steps from the step a to the step e.

6. The detecting method of claim 5, wherein the method further comprises:
f) following step a1, if yes, the image sense unit sensing a first image to defining a start point of the portable electronic device;
g) sensing a second image by the image sense unit;
h) analyzing the differences of image translation factors between the first image and the second image to generate motion data by the process unit;
i) sending the control signal corresponding to the translation motion according to the motion data;
j) replacing the first image with the second image to redefine the start point.

7. The detecting method of claim 1, wherein the control signal controls action of an object displayed in a display unit of the portable electronic device.
